(19) United States
(12) Patent Application Publication
(10) Pub. No.: US 2020/0150322 A1
(43) Pub. Date: May 14, 2020

(54) GRATING PLATE DEVICE

(71) Applicant: inFilm Optoelectronic Inc., Grand Cayman (KY)

(72) Inventor: Chih-Hsiung LIN, Grand Cayman (KY)

(73) Assignee: inFilm Optoelectronic Inc., Grand Cayman (KY)

(21) Appl. No.: 16/662,417

(22) Filed: Oct. 24, 2019

(30) Foreign Application Priority Data
Nov. 9, 2018 (CN) 201811329680.6

(51) Int. Cl. G02B 5/18; F21V 8/00

(52) U.S. Cl. CPC G02B 5/1823; G02B 5/1842; G02B 6/009; G02B 6/0068; G02B 6/0036

(57) ABSTRACT

A grating plate device includes a light transmitting substrate, a plurality of first diffraction gratings, and a plurality of second diffraction gratings. The light transmitting substrate includes a first surface and a second surface, the first surface has a first imaging area and a second imaging area. The first diffraction gratings are disposed on the first imaging area, and each of the first diffraction gratings includes two first grating lines parallel to each other and a first slit between the two first grating lines. The second diffraction gratings are disposed on the second imaging area, each of the second diffraction gratings includes two second grating lines parallel to each other and a second slit between the two second grating lines, and the first diffraction gratings are not parallel to the second diffraction gratings or a width of the first slit is different from a width of the second slit.

### CROSS-REFERENCE TO RELATED APPLICATION

This non-provisional application claims priority under 35 U.S.C. § 119(a) to Patent Application No. 201811329680.6 filed in China, P.R.C. on Nov. 9, 2018, the entire contents of which are hereby incorporated by reference.

### BACKGROUND

### Technical Field

The instant disclosure relates to an optical device, and in particular, to a grating plate device.

### Related Art

Grating plate is one of common display technologies at present, and is widely applied to various advertising light boxes, advertising billboards, portrait photos, anti-counterfeiting technology or naked-eye 3D development technology, and the like.

In general, a grating plate on the market is provided with a grating on one of surfaces, where the grating includes a plurality of equidistant parallel slits. For example, a plurality of parallel nicks may be cut in a glass sheet, each nick is a light-tight part, and a smooth part between two nicks is a light transmitting part, thus forming a slit. However, in a current method for grating plate imaging, an image is printed or overlaid on another surface of the grating plate, so that when a user views an image through the grating, a different visual perception (such as a stereoscopic effect) may be generated.

### SUMMARY

In view of the foregoing, in an embodiment, a grating plate device is provided. The grating plate device includes a light transmitting substrate, a plurality of first diffraction gratings, and a plurality of second diffraction gratings. The light transmitting substrate includes a first surface and a second surface that are opposite to each other, where the first surface has a first imaging area and a second imaging area. The plurality of first diffraction gratings is disposed on the first imaging area of the first surface and parallel to each other, and each of the first diffraction gratings includes two first grating lines parallel to each other and a first slit between the two first grating lines. The plurality of second diffraction gratings is disposed on the second imaging area of the first surface and parallel to each other, each of the second diffraction gratings includes two second grating lines parallel to each other and a second slit between the two second grating lines, and the first diffraction gratings are not parallel to the second diffraction gratings.

In an embodiment, a grating plate device is provided. The grating plate device includes a light transmitting substrate, a plurality of first diffraction gratings, and a plurality of second diffraction gratings. The light transmitting substrate includes a first surface and a second surface that are opposite to each other, where the first surface has a first imaging area and a second imaging area. The plurality of first diffraction gratings is disposed on the first imaging area of the first surface and parallel to each other, each of the first diffraction gratings includes two first grating lines parallel to each other and a first slit between the two first grating lines, and the first slit has a first slit width. The plurality of second diffraction gratings is disposed on the second imaging area of the first surface and parallel to each other, each of the second diffraction gratings includes two second grating lines parallel to each other and a second slit between the two second grating lines, the second slit has a second slit width, and the first slit width is different from the second slit width.

As above, in the grating plate device provided in the embodiments of the instant disclosure, diffraction gratings with different forms (such as different directions or different slit widths) are respectively disposed on a plurality of different imaging areas on the surface of the light transmitting substrate, so that the same light transmitting substrate may generate different images or overlapping images when irradiated by light in different forms, to save costs and better satisfy diversified demand of users.

### BRIEF DESCRIPTION OF THE DRAWINGS

The disclosure will become more fully understood from the detailed description given herein below for illustration only, and thus not limitative of the disclosure, wherein:

FIG. 1 illustrates a top view of a grating plate device according to a first embodiment of the instant disclosure;

FIG. 2 illustrates an enlarged view of an overlapping area in the grating plate device according to the first embodiment of the instant disclosure;

FIG. 3 illustrates a three-dimensional diagram of the grating plate device according to the first embodiment of the instant disclosure;

FIG. 4 illustrates a cross-sectional view taken along line A-A of FIG. 1;

FIG. 5 illustrates a schematic diagram of imaging of the grating plate device according to the first embodiment of the instant disclosure;

FIG. 6 illustrates a cross-sectional view taken along line B-B of FIG. 1;

FIG. 7 illustrates another schematic diagram of imaging of the grating plate device according to the first embodiment of the instant disclosure;

FIG. 8 illustrates a three-dimensional diagram of a grating plate device according to a second embodiment of the instant disclosure;

FIG. 9 illustrates a local schematic diagram of a grating plate device according to a third embodiment of the instant disclosure;

FIG. 10 illustrates a local schematic diagram of a grating plate device according to a fourth embodiment of the instant disclosure;

FIG. 11 illustrates a schematic diagram of irradiation of a grating plate device according to another embodiment of the instant disclosure; and

FIG. 12 illustrates a schematic diagram of irradiation of a grating plate device according to yet another embodiment of the instant disclosure.

### DETAILED DESCRIPTION

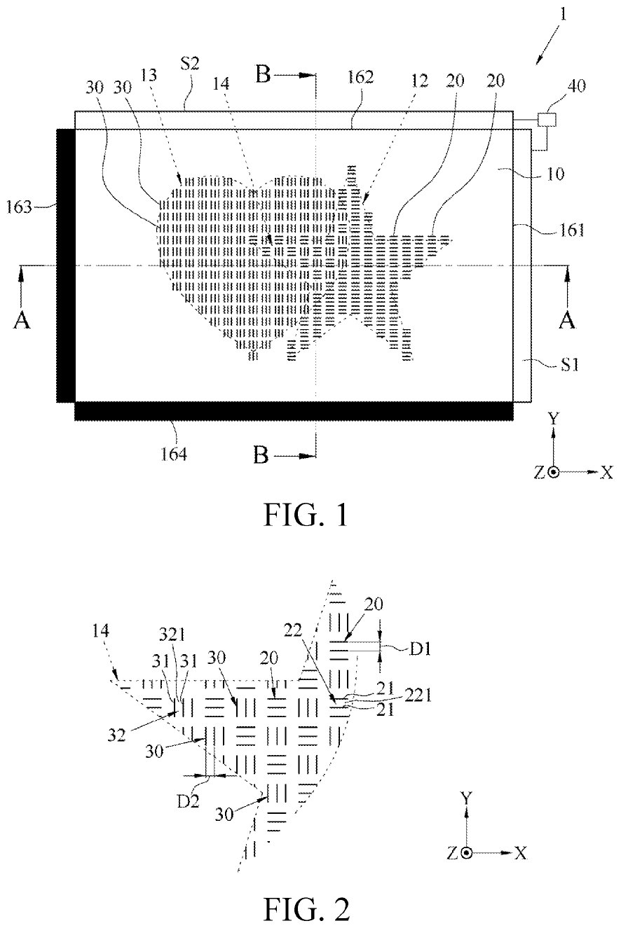

As shown in FIG. 1 and FIG. 2, a grating plate device 1 includes a light transmitting substrate 10 and a plurality of groups of different diffraction gratings. For example, in this embodiment, the grating plate device 1 includes two groups of diffraction gratings, the first group of diffraction gratings includes a plurality of first diffraction gratings 20, and the second group of diffraction gratings includes a plurality of second diffraction gratings 30. In some embodiments, the grating plate device 1 may be applied to various display technologies such as advertising light boxes, advertising billboards, portrait photos, and anti-counterfeiting technology or naked-eye 3D, which are not limited herein.

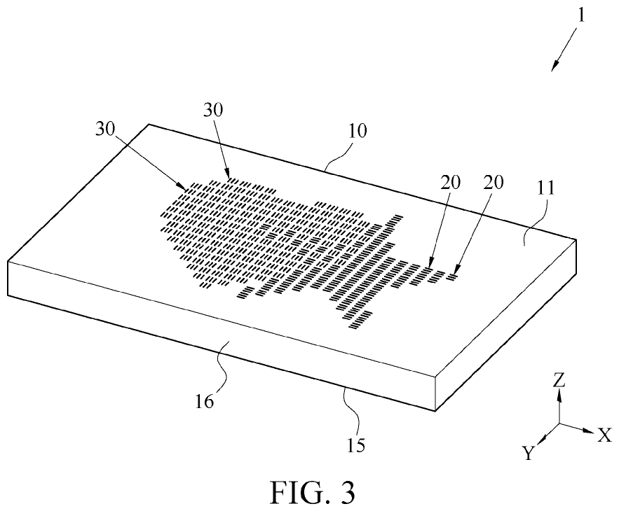

As shown in FIG. 1 and FIG. 3, the light transmitting substrate 10 has a circumferential surface 16 as well as a first surface 11 and a second surface 15 that are opposite to each other, where the first surface 11 is spaced apart from the second surface 15 due to a thickness of the light transmitting substrate 10. The circumferential surface 16 is connected to outer circumferences of the first surface 11 and the second surface 15. In some embodiments, the light transmitting substrate 10 may be specifically made of light guiding material. For example, the light transmitting substrate 10 may be made of a transparent material such as polycarbonate (PC), polymethyl methacrylate (PMMA), glass or other transparent plastic, and therefore has a light guiding function. In addition, the light transmitting substrate 10 may be a hard light guiding plate or a flexible soft light guiding sheet, which is not limited herein.

Further, as shown in FIG. 1 and FIG. 3, the first surface 11 of the light transmitting substrate 10 has a plurality of imaging areas, and shapes of the imaging areas may be the same or different. For example, in this embodiment, the first surface 11 of the light transmitting substrate 10 has a first imaging area 12 and a second imaging area 13, where the first imaging area 12 is a star-shaped area represented by a dotted line frame in FIG. 1, and the second imaging area 13 is a heart-shaped area represented by a dotted line frame in FIG. 1. This embodiment is merely used as an example. In other embodiments, the first imaging area 12 and the second imaging area 13 may be designed as other patterns according to product requirements, or the first surface 11 of the light transmitting substrate 10 may alternatively have more than two imaging areas. In addition, as shown in FIG. 1 and FIG. 2, in this embodiment, the first imaging area 12 and the second imaging area 13 partially overlap to form an overlapping area 14. FIG. 2 is an enlarged view of the overlapping area 14 in FIG. 1, which is not limited herein. In other embodiments, the first imaging area 12 and the second imaging area 13 may not overlap or may totally overlap.

As shown in FIG. 1 and FIG. 2, the plurality of first diffraction gratings 20 is disposed on the first imaging area 12 of the first surface 11 and parallel to each other, that is, the plurality of first diffraction gratings 20 is distributed all over the entire first imaging area 12. Each of the first diffraction gratings 20 includes a plurality of first grating lines 21 parallel to each other and a plurality of first slits 22 between the plurality of first grating lines 21. In some embodiments, the first grating lines 21 may be nicks formed on the first surface 11 by etching or other processing methods, the first grating lines 21 are light-tight parts, and the first slits 22 between the plurality of first grating lines 21 are light transmitting parts.

As shown in FIG. 1 and FIG. 2, each of the first diffraction gratings 20 on the first imaging area 12 includes three first grating lines 21 parallel to each other and two first slits 22 between the three first grating lines 21. In this embodiment, each of the first grating lines 21 is parallel to an X-axis direction, but is not limited to being parallel to the X-axis direction. In fact, the quantities or angles of the first grating lines 21 and the first slits 22 of each of the first diffraction gratings 20 may be changed according to actual product demand.

As shown in FIG. 1 and FIG. 2, the plurality of second diffraction gratings 30 is disposed on the second imaging area 13 of the first surface 11 and parallel to each other, that is, the plurality of second diffraction gratings 30 is distributed all over the entire second imaging area 13. Each of the second diffraction gratings 30 includes a plurality of second grating lines 31 parallel to each other and a plurality of second slits 32 between the plurality of second grating lines 31. In some embodiments, the second grating lines 31 may be nicks formed on the first surface 11 by etching or other processing methods, the second grating lines 31 are light-tight parts, and the second slits 32 between the plurality of second grating lines 31 are light transmitting parts.

As shown in FIG. 1 to FIG. 3, each of the second diffraction gratings 30 on the second imaging area 13 includes three second grating lines 31 parallel to each other and two second slits 32 between the three second grating lines 31, and the first diffraction gratings 20 are not parallel to the second diffraction gratings 30. For example, in this embodiment, the first grating lines 21 of the first diffraction gratings 20 are parallel to an X-axis direction, and the second grating lines 31 of the second diffraction gratings 30 are perpendicular to the first grating lines 21 and are parallel to an Y-axis direction, that is, the first grating lines 21 and the second grating lines 31 form an angle of 90 degrees. The angle is not limited herein. In fact, the quantities or angles of the second grating lines 31 and the second slits 32 of each of the second diffraction gratings 30 may be changed according to actual product demand. For example, the second grating lines 31 of the second diffraction gratings 30 and the first grating lines 21 of the first diffraction gratings 20 may alternatively form an angle of 30 degrees, 45 degrees, or 60 degrees where the second grating lines 31 are not parallel to the first grating lines 21.

As shown in FIG. 1 and FIG. 2, in the overlapping area 14 between the first imaging area 12 and the second imaging area 13, the plurality of first diffraction gratings 20 and the plurality of second diffraction gratings 30 are respectively disposed at different positions on the first surface 11 and do not overlap. For example, in this embodiment, the plurality of first diffraction gratings 20 and the plurality of second diffraction gratings 30 are arranged to be staggered with each other, but the arrangement is not limited thereto. The plurality of first diffraction gratings 20 and the plurality of second diffraction gratings 30 may alternatively be arranged in other ways.

Therefore, in the embodiments of the instant disclosure, the first imaging area 12 of the light transmitting substrate 10 of the grating plate device 1 may emit light according to irradiation of light corresponding to the plurality of first diffraction gratings 20. The second imaging area 13 may emit light according to irradiation of light corresponding to the plurality of second diffraction gratings 30. A detailed description with reference to the drawings is as follows:

As shown in FIG. 1 and FIG. 2, in this embodiment, the first slit 22 of each of the first diffraction gratings 20 on the first imaging area 12 has a first incident end 221, the circumferential surface 16 of the light transmitting substrate 10 has a first light entry area 161, and the first light entry area 161 is located in a direction of the first incident end 221. From perspectives of FIG. 1 and FIG. 2, the first incident end 221 is a right end of the first slit 22, and the first light entry area 161 is a right side of the circumferential surface 16 and is located in the direction of the first incident end 221. The second slit 32 of each of the second diffraction gratings 30 on the second imaging area 13 has a second incident end 321, the circumferential surface 16 of the light transmitting substrate 10 has a second light entry area 162, and the second light entry area 162 is located in a direction of the second incident end 321. From perspectives of FIG. 1 and FIG. 2, the second incident end 321 is an upper end of the second slit 32, and the second light entry area 162 is an upper side of the circumferential surface 16 and is located in the direction of the second incident end 321. Therefore, when external light enters from the first light entry area 161, the first imaging area 12 can emit light, and when external light enters from the second light entry area 162, the second imaging area 13 can emit light.

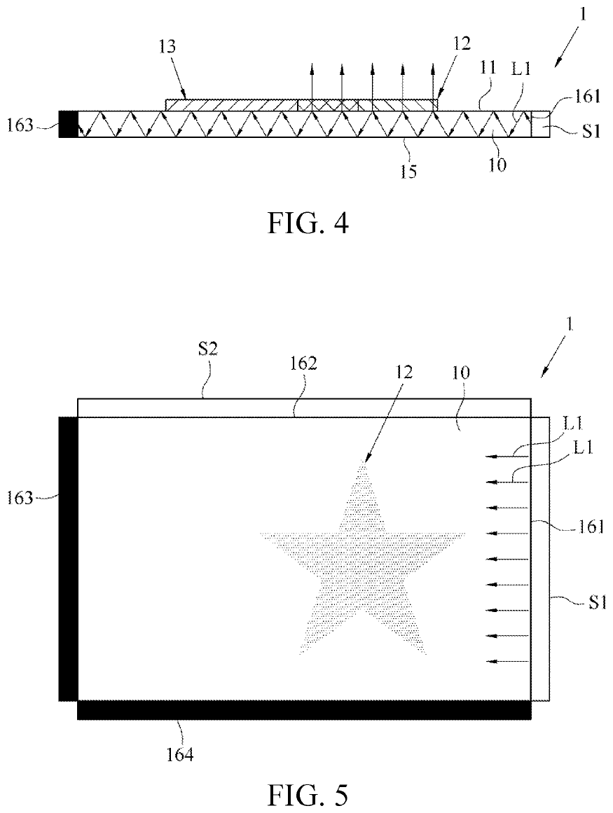

For example, as shown in FIG. 1 and FIG. 2, the grating plate device 1 may be provided with a first light source S1 and a second light source S2, where the first light source S1 is used to correspondingly irradiate the plurality of first diffraction gratings 20 to emit light, and the second light source S2 is used to correspondingly irradiate the plurality of second diffraction gratings 30 to emit light. In this embodiment, the first light source S1 and the second light source S2 are respectively disposed on the first light entry area 161 and the second light entry area 162 of the circumferential surface 16 of the light transmitting substrate 10. The first light source S1 and the second light source S2 may be connected to a controller 40 (such as a manual switch or a remote switch). In some embodiments, the first light source S1 and the second light source S2 may be laser light sources, LED lights, or incandescent lights, which are not limited herein. With reference to FIG. 4 and FIG. 5, the controller 40 may control the first light source S1 to emit first light L1 that enters from the first light entry area 161. Because an incidence direction of the first light L1 is parallel to the first slits 22, the first light L1 may enter via the first incident ends 221 of the first slits 22 (as shown in FIG. 4, the first light L1 is totally reflected in the light transmitting substrate 10 for a plurality of times and enters the first slits 22 via the first incident ends 221), so that the first light L1 may be diffracted and interfered in the first slits 22. Therefore, the entire first imaging area 12 emits light to present a star pattern. In addition, because the second diffraction gratings 30 are not parallel to the first diffraction gratings 20, the first light L1 may be blocked by the second grating lines 31 and fail to enter the plurality of second slits 32, so that the second imaging area 13 does not emit light.

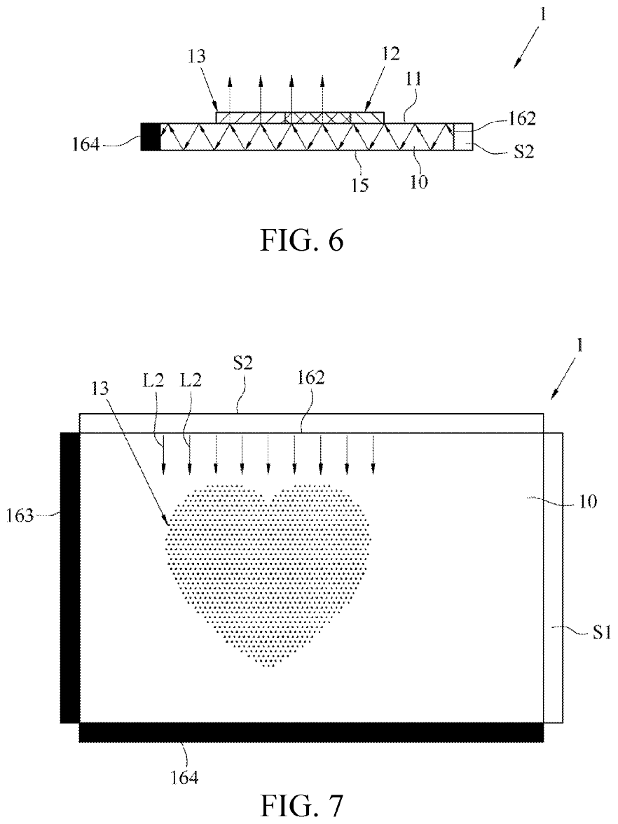

As shown in FIG. 1, FIG. 2, FIG. 6, and FIG. 7, the controller 40 may alternatively control the second light source S2 to emit second light L2 that enters from the second light entry area 162, and incidence directions of the first light L1 and the second light L2 are different. Because the incidence direction of the second light L2 is parallel to the second slits 32, the second light L2 may enter via the second incident ends 321 of the second slits 32 (as shown in FIG. 6, the second light L2 is totally reflected in the light transmitting substrate 10 for a plurality of times and enters the second slits 32 via the second incident ends 321), so that the second light L2 may be diffracted and interfered in the second slits 32. Therefore, the second imaging area 13 emits light to show a heart pattern. In addition, because the second diffraction gratings 30 are not parallel to the first diffraction gratings 20, the second light L2 may be blocked by the first grating lines 21 and fail to enter the plurality of first slits 22, so that the first imaging area 12 does not emit light. In some embodiments, the controller 40 may alternatively control both the first light source S1 and the second light source S2 to emit light, so that both the first imaging area 12 and the second imaging area 13 emit light to present a composite pattern combining a star and a heart.

In summary, in the embodiments of the instant disclosure, diffraction gratings pointing to different directions are disposed in the first imaging area 12 and the second imaging area 13, so that the same light transmitting substrate 10 may generate different images or an overlapping image when irradiated by light at different angles (namely, incidence directions), to save costs and satisfy diversified demand of users. In addition, in the grating plate device 1 provided in the embodiments of the instant disclosure, the plurality of imaging areas (the first imaging area 12 and the second imaging area 13) of the light transmitting substrate 10 at least partially overlap, to achieve the effect of configuring more different patterns in a limited area.

As shown in FIG. 1, FIG. 5, and FIG. 7, in some embodiments, the circumferential surface 16 of the light transmitting substrate 10 further has a first light absorption area 163 and a second light absorption area 164, where the first light absorption area 163 is opposite to the first light entry area 161, and the second light absorption area 164 is opposite to the second light entry area 162. For example, the first light absorption area 163 and the second light absorption area 164 may be provided with light absorbing material. For example, the first light absorption area 163 and the second light absorption area 164 may be printed or coated with a dark ink layer (such as a black or brown ink layer). The first light absorption area 163 and the second light absorption area 164 may be each provided with a dark plastic sheet. For example, the dark plastic sheets may be fixed to surfaces of the first light absorption area 163 and the second light absorption area 164 by adhesion, hot melting, or attachment, so that when transmitted to the first light absorption area 163 or the second light absorption area 164, incident light from the first light entry area 161 or the second light entry area 162 is not reflected back into the light transmitting substrate 10 to interfere with incident light.

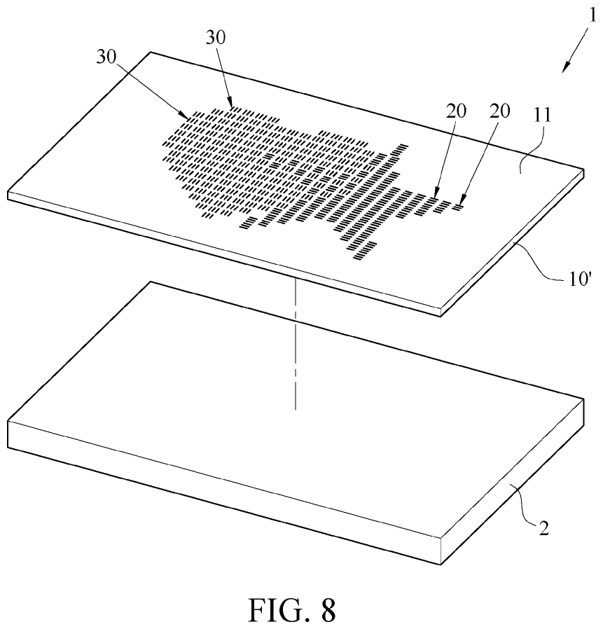

FIG. 8 is a three-dimensional diagram of a second embodiment of the instant disclosure. In this embodiment, a light transmitting substrate 10′ may alternatively be a light transmitting sheet body made of a photosensitive material (such as silver halide, photoresist, and photopolymer), so that a plurality of first diffraction gratings 20 and a plurality of second diffraction gratings 30 are in the light transmitting substrate 10′ by laser processing or other processing methods (such as rolling, flat pressing, and injection molding). The light transmitting substrate 10′ may be stacked and fixed (for example, adhered) to a light guiding plate 2, and external light may enter the first slits 22 of the first diffraction gratings 20 or the second slits 32 of the second diffraction gratings 30 through the light guiding plate 2, which is not limited herein. Alternatively, the external light may directly enter the light transmitting substrate 10′.

As shown in FIG. 1 and FIG. 2, in this embodiment, the first diffraction gratings 20 are not parallel to the second diffraction gratings 30, and a first slit width D1 (that is, a spacing between two first grating lines 21) of the first slits 22 of the first diffraction gratings 20 is the same as a second slit width D2 (that is, a spacing between two second grating lines 31) of the second slits 32 of the second diffraction gratings 30. This is not limited herein. Alternatively, the first diffraction gratings 20 and the second diffraction gratings 30 may be implemented in other forms, and examples are as follows.

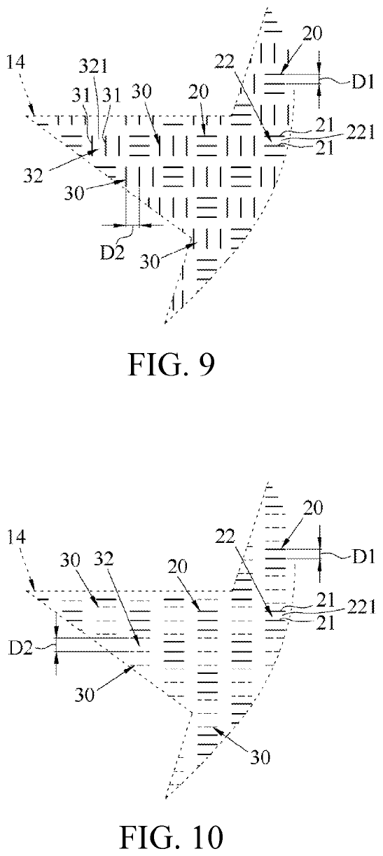

As shown in FIG. 9, in some embodiments, the first diffraction gratings 20 may not be parallel to the second diffraction gratings 30, and the first slit width D1 of the first slits 22 of the first diffraction gratings 20 may be different from the second slit width D2 of the second slits 32 of the second diffraction gratings 30 (for example, in FIG. 9, the second slit width D2 is greater than the first slit width D1), so that the first diffraction gratings 20 and the second diffraction gratings 30 may not only correspond to light at different angles but also correspond to light with different optical properties (such as wavelength, color, or frequency). For example, the first slit width D1 of the first slits 22 of the first diffraction gratings 20 may correspond to a wavelength of green light (that is, the first slits 22 allow only green light to enter and diffract), and the second slit width D2 of the second slits 32 of the second diffraction gratings 30 may correspond to a wavelength of red light (that is, the first slits 22 allow only red light to enter and diffract).

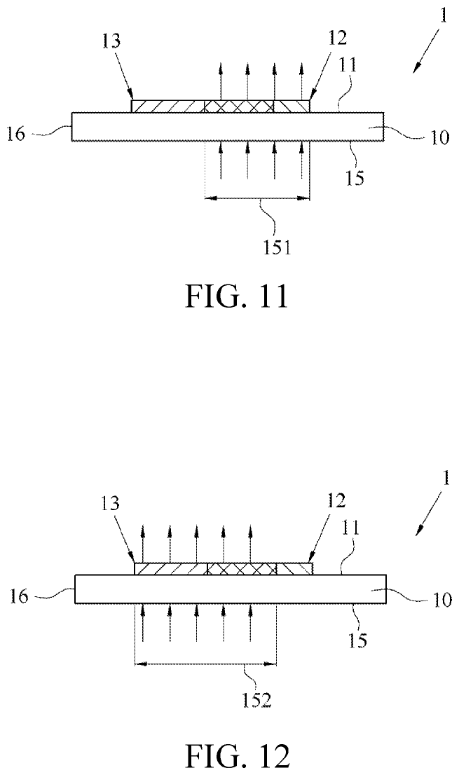

To be specific, referring to FIG. 1 and FIG. 9, the first light source S1 may be a green light source, and the second light source S2 may be a red light source. When the first light source S1 emits green light, the green light only diffracts and interferes in the first slits 22 of the first diffraction gratings 20 on the first imaging area 12, so that the first imaging area 12 emits light to present a star pattern. On the contrary, when the second light source S2 emits red light, the red light only diffracts and interferes in the second slits 32 of the second diffraction gratings 30 on the second imaging area 13, so that the second imaging area 13 emits light to present a heart pattern. In addition, in this embodiment, the green light and the red light may respectively irradiate the first imaging area 12 and the second imaging area 13 from the second surface 15 of the light transmitting substrate 10, and light is not limited to entering from the circumferential surface 16 of the light transmitting substrate 10. As shown in FIG. 11 and FIG. 12, the second surface 15 may have a first light entry area 151 and a second light entry area 152, where the first light entry area 151 corresponds to the first imaging area 12, and the second light entry area 152 corresponds to the second imaging area 13. External green light may enter the first imaging area 12 via the first light entry area 151 (as shown in FIG. 11) to present a star pattern, and external red light may enter the second imaging area 13 via the second light entry area 152 (as shown in FIG. 12) to present a heart pattern.

Further, as shown in FIG. 10, in another embodiment, the first diffraction gratings 20 may alternatively be parallel to the second diffraction gratings 30 (in the figure, the second diffraction gratings 30 are represented by dotted lines to be distinguished from the first diffraction gratings 20). For example, both the first diffraction gratings 20 and the second diffraction gratings 30 are parallel to the X-axis in FIG. 1, and the first slit width D1 of the first slits 22 of the first diffraction gratings 20 is different from the second slit width D2 of the second slits 32 of the second diffraction gratings 30 (for example, in FIG. 10, the second slit width D2 is greater than the first slit width D1), to correspond to light with different optical properties (such as wavelength, color, or frequency). For example, the first slit width D1 of the first slits 22 of the first diffraction gratings 20 may correspond to the wavelength of green light (that is, the first slits 22 allow only green light to enter and diffract), and the second slit width D2 of the second slits 32 of the second diffraction gratings 30 may correspond to the wavelength of red light (that is, the first slits 22 allow only red light to enter and diffract). Therefore, when external green light of which an incidence direction is parallel to the first diffraction gratings 20 and the second diffraction gratings 30 enters the light transmitting substrate 10, the green light only diffracts and interferes in the first slits 22 of the first diffraction gratings 20 on the first imaging area 12, so that the first imaging area 12 emits light to present a star pattern. When external red light of which an incidence direction is parallel to the first diffraction gratings 20 and the second diffraction gratings 30 enters the light transmitting substrate 10, the red light only diffracts and interferes in the second slits 32 of the second diffraction gratings 30 on the second imaging area 13, so that the second imaging area 13 emits light to present a heart pattern. For example, the first light entry area 161 of the grating plate device 1 may be provided with a light source (for example, the first light source S1 shown in FIG. 1), the light source may selectively emit the green light or the red light with the same incidence direction to enable the first imaging area 12 or the second imaging area 13 to emit light. In addition, in this embodiment, the green light or the red light may irradiate the first imaging area 12 and the second imaging area 13 via the second surface 15 of the light transmitting substrate 10 (as shown in FIG. 11 and FIG. 12), and is not limited to entering from the circumferential surface 16 of the light transmitting substrate 10.

Although technical content of the instant disclosure is disclosed above in the preferred embodiments, the embodiments are not intended to limit the instant disclosure. Any changes and modifications made by those skilled in the art without departing from the spirit of the instant disclosure shall fall within the scope of the instant disclosure. Therefore, the protection scope of the instant disclosure should be subject to the appended claims.

What is claimed is:

1. A grating plate device, comprising:
a light transmitting substrate, comprising a first surface and a second surface that are opposite to each other, the first surface having a first imaging area and a second imaging area;
a plurality of first diffraction gratings, disposed on the first imaging area of the first surface and parallel to each other, each of the first diffraction gratings comprising two first grating lines parallel to each other and a first slit between the two first grating lines; and
a plurality of second diffraction gratings, disposed on the second imaging area of the first surface and parallel to each other, each of the second diffraction gratings comprising two second grating lines parallel to each other and a second slit between the two second grating lines, the first diffraction gratings being not parallel to the second diffraction gratings.

2. The grating plate device according to claim 1, wherein the first slit has a first slit width and the second slit has a second slit width, the first slit width being different from the second slit width.

3. The grating plate device according to claim 1, wherein the first imaging area and the second imaging area at least partially overlap to form an overlapping area, and the first diffraction gratings and the second diffraction gratings located on the overlapping area are respectively disposed at different positions on the first surface.

4. The grating plate device according to claim 1, further comprising a first light source and a second light source, wherein the first light source provides a first light that correspondingly irradiates the first diffraction gratings to emit light, and the second light source provides a second light that correspondingly irradiates the second diffraction gratings to emit light.

5. The grating plate device according to claim 4, wherein the first light and the second light have different incidence directions.

6. The grating plate device according to claim 4, wherein the first light and the second light are respectively totally reflected in the light transmitting substrate for a plurality of times.

7. The grating plate device according to claim 4, wherein optical properties of the first light are different from optical properties of the second light.

8. The grating plate device according to claim 1, further comprising a light source, wherein the light source selectively provides a first light or a second light, the first light correspondingly irradiates the first diffraction gratings to emit light, and the second light correspondingly irradiates the second diffraction gratings to emit light.

9. The grating plate device according to claim 8, wherein the first light and the second light are respectively totally reflected in the light transmitting substrate for a plurality of times.

10. The grating plate device according to claim 8, wherein optical properties of the first light are different from optical properties of the second light.

11. A grating plate device, comprising:
a light transmitting substrate, comprising a first surface and a second surface that are opposite to each other, the first surface having a first imaging area and a second imaging area;
a plurality of first diffraction gratings, disposed on the first imaging area of the first surface and parallel to each other, each of the first diffraction gratings comprising two first grating lines parallel to each other and a first slit between the two first grating lines, the first slit having a first slit width; and
a plurality of second diffraction gratings, disposed on the second imaging area of the first surface and parallel to each other, each of the second diffraction gratings comprising two second grating lines parallel to each other and a second slit between the two second grating lines, the second slit having a second slit width, the first slit width being different from the second slit width.

12. The grating plate device according to claim 11, wherein the first imaging area and the second imaging area at least partially overlap to form an overlapping area, and the first diffraction gratings and the second diffraction gratings located on the overlapping area are respectively disposed at different positions on the first surface.

13. The grating plate device according to claim 11, further comprising a first light source and a second light source, wherein the first light source provides a first light that correspondingly irradiates the first diffraction gratings to emit light, and the second light source provides a second light that correspondingly irradiates the second diffraction gratings to emit light.

14. The grating plate device according to claim 13, wherein the first light and the second light have different incidence directions.

15. The grating plate device according to claim 13, wherein the first light and the second light are respectively totally reflected in the light transmitting substrate for a plurality of times.

16. The grating plate device according to claim 13, wherein optical properties of the first light are different from optical properties of the second light.

17. The grating plate device according to claim 11, further comprising a light source, wherein the light source selectively provides a first light or a second light, the first light correspondingly irradiates the first diffraction gratings to emit light, and the second light correspondingly irradiates the second diffraction gratings to emit light.

18. The grating plate device according to claim 17, wherein the first light and the second light are respectively totally reflected in the light transmitting substrate for a plurality of times.

19. The grating plate device according to claim 17, wherein optical properties of the first light are different from optical properties of the second light.
